(19) United States
(12) Patent Application Publication
(10) Pub. No.: US 2021/0235932 A1
(43) Pub. Date: Aug. 5, 2021

(54) Temperature Controlled Storage Assembly

(71) Applicant: Elaine Williams, Twinsburg, OH (US)

(72) Inventor: Elaine Williams, Twinsburg, OH (US)

(21) Appl. No.: 16/777,395

(22) Filed: Jan. 30, 2020

(51) Int. Cl. A47J 41/00; A47J 36/24

(52) U.S. Cl. CPC A47J 41/0044; A47J 36/2494; A47J 41/0061; A47J 41/005

(57) ABSTRACT

A temperature controlled storage assembly for food and beverages includes a housing, which defines an interior space, and a bowl. The housing has a recess extending into an upper face thereof. A thermal energy storage material can be selectively positioned in the interior space. The bowl comprises a bottom, which has a lower sidewall coupled thereto and extending therefrom. The lower sidewall has an upper sidewall coupled thereto and extending therefrom to define a top of the bowl. The top is open for insertion of an article into the bowl, such as a foodstuff or a beverage. The lower sidewall is inserted into the recess to selectively engage the housing. At least one of the bottom and the lower sidewall of the bowl transfer heat between the thermal energy storage material and the article.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage assemblies and more particularly pertains to a new storage assembly for food and beverages.

### (2) Description of Related Art Including Information Disclosed Under 37 CFR 1.97 and 1.98

The prior art relates to storage assemblies, and more particularly to temperature controlled storage assemblies for food and beverages. Prior art storage assemblies may comprise a two nestable containers that are configured for positioning ice and water therebetween, purpose built refrigeration units, and jacketed containers having a thermal energy storage material positioned between a pair of walls.

### BRIEF SUMMARY OF THE INVENTION

An embodiment of the disclosure meets the needs presented above by generally comprising a housing, which defines an interior space, and a bowl. The housing has a recess extending into an upper face thereof. The housing is configured for selectively positioning of a thermal energy storage material in the interior space. The bowl comprises a bottom, which has a lower sidewall coupled thereto and extending therefrom. The lower sidewall has an upper sidewall coupled thereto and extending therefrom to define a top of the bowl. The top is open and is configured for insertion of an article into the bowl. The lower sidewall is configured to be inserted into the recess and to selectively engage the housing. At least one of the bottom and the lower sidewall of the bowl is configured for heat transfer between the thermal energy storage material and the article.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a temperature controlled storage assembly according to an embodiment of the disclosure.

FIG. 2 is an exploded view of an embodiment of the disclosure.

FIG. 3 is a bottom view of an embodiment of the disclosure.

FIG. 4 is a partial cross-sectional view of an embodiment of the disclosure.

### DETAILED DESCRIPTION OF THE INVENTION

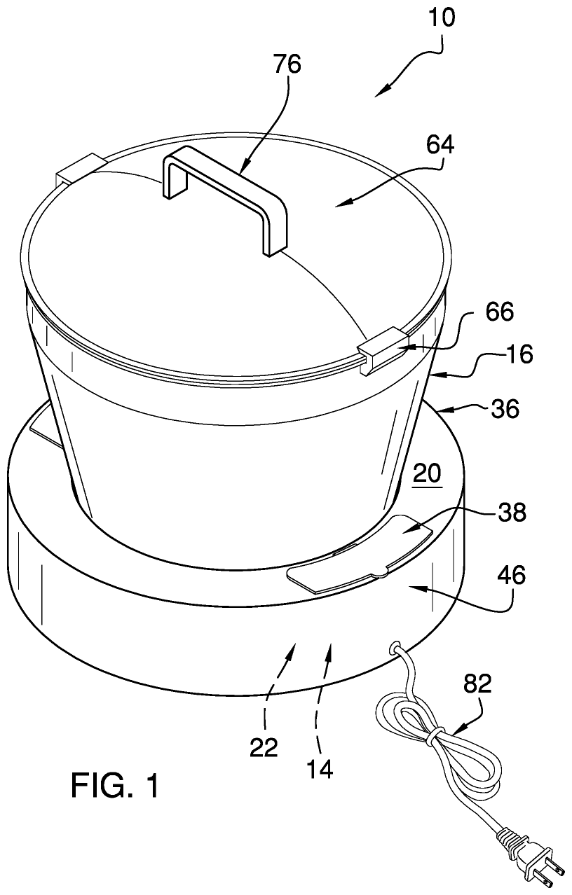

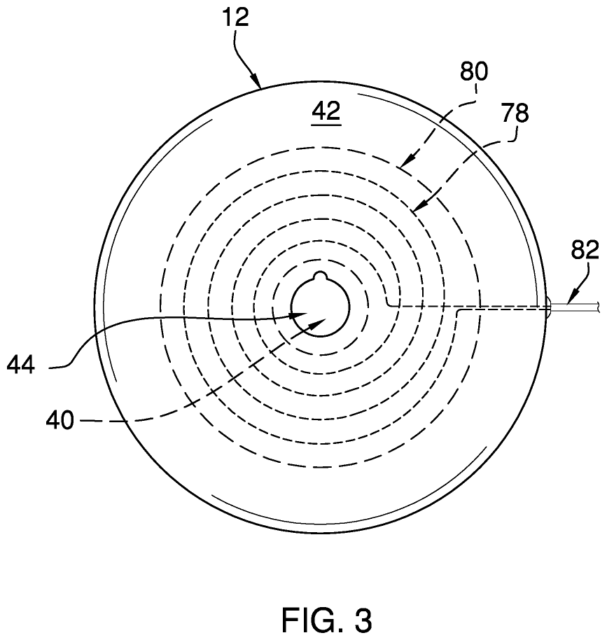

With reference now to the drawings, and in particular to FIGS. 1 through 4 thereof, a new storage assembly embodying the principles and concepts of an embodiment of the disclosure and generally designated by the reference numeral 10 will be described.

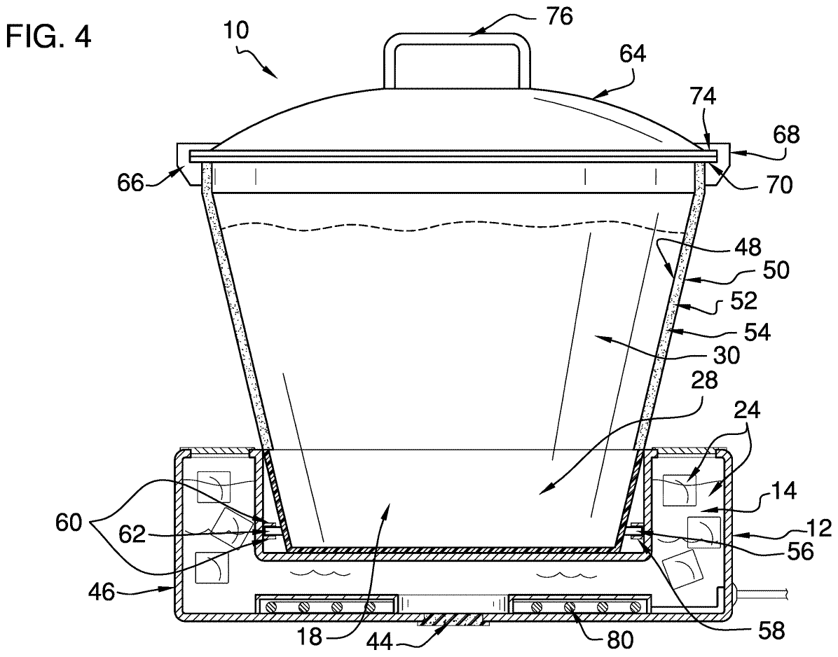

As best illustrated in FIGS. 1 through 4, the temperature controlled storage assembly 10 generally comprises a housing 12, which defines an interior space 14, and a bowl 16. The housing 12 has a recess 18 extending into an upper face 20 thereof. The housing 12 is configured for selectively positioning of a thermal energy storage material 22 in the interior space 14. The thermal energy storage material 22 may comprise ice and water 24, as shown in FIG. 4.

The bowl 16 comprises a bottom 26, which has a lower sidewall 28 coupled thereto and extending therefrom. The lower sidewall 28 has an upper sidewall 30 coupled thereto and extending therefrom to define a top 32 of the bowl 16. The top 32 is open and is configured for insertion of an article into the bowl 16. The lower sidewall 28 is configured to be inserted into the recess 18 and to selectively engage the housing 12. At least one of the bottom 26 and the lower sidewall 28 of the bowl 16 is configured for heat transfer between the thermal energy storage material 22 and the article. The lower sidewall 28 may extend transversely from the bottom 26, as shown in FIG. 4. The present invention also anticipates the lower sidewall 28 extending perpendicularly (not shown) from the bottom 26 to provide additional contact between the lower sidewall 28 and the housing 12.

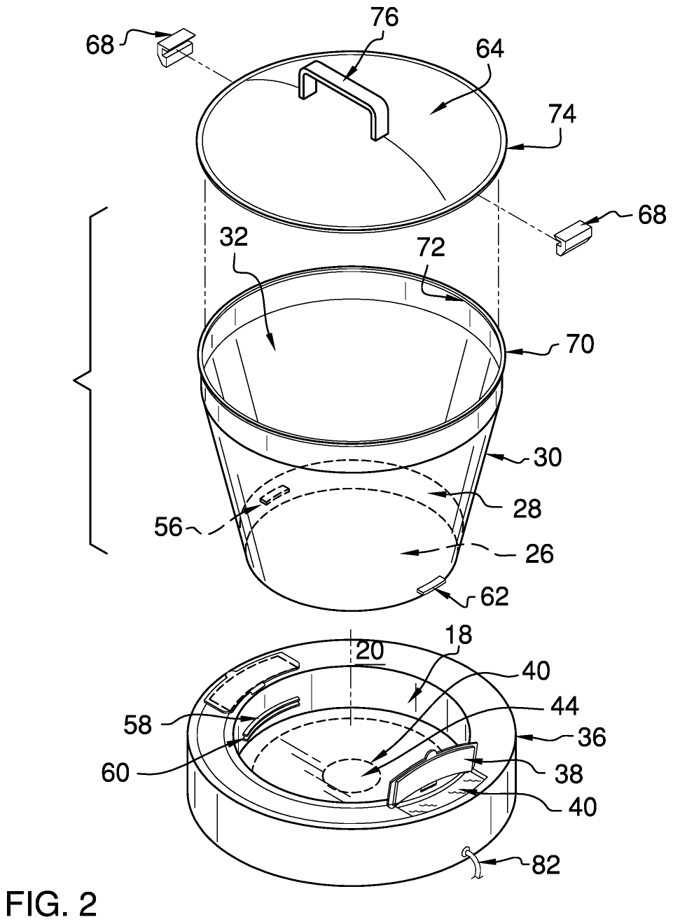

The housing 12 has an orifice 34 positioned in the upper face 20 between the recess 18 and a circumference 36 of the upper face 20. The orifice 34 is configured for addition of the thermal energy storage material 22 to the interior space 14. A panel 38 is hingedly engaged to the housing 12 proximate to the orifice 34, as shown in FIG. 2, and is configured to selectively engage the housing 12 to close the orifice 34. The housing 12 may be substantially disc shaped, as shown in FIG. 2, or alternatively shaped, such as, but not limited to, rectangularly box shaped, and the like.

A cutout 40 is positioned in a lower face 42 of the housing 12 to drain the thermal energy storage material 22 from the interior space 14. A plug 44 selectively engageable to the housing 12, by insertion into the cutout 40, so that the plug 44 is positioned to close the cutout 40. The present invention also anticipates the cutout 40 being positioned in a side 46 of the housing 12 (not shown) adjacent to the lower face 42.

The upper sidewall 30 is insulated. The upper sidewall 30 may comprise an inner wall 48 and an outer wall 50 that define an internal space 52, as shown in FIG. 4. The internal space 52 is substantially occupied by an insulator 54 to decrease heat transfer between the article in the bowl 16 and an ambient environment is which the assembly 10 is positioned. The present invention also anticipates other insulating means for decreasing heat transfer between the article in the bowl 16 and the ambient environment, such as, but not limited to, insulating sleeves, wraps, and the like.

A first connector 56 is engaged to the lower sidewall 28. A second connector 58 is engaged to the housing 12 within the recess 18. The second connector 58 is complementary to the first connector 56 and thus is positioned to selectively engage the first connector 56 to couple the bowl 16 to the housing 12. In one embodiment, as shown in FIG. 2, the recess 18 is substantially circularly shaped. In this embodiment, the second connector 58 may comprise a track 60, and the first connector 56 may comprise a tab 62. The track 60 is positioned to insert the tab 62 as the lower sidewall 28 of the bowl 16 is rotated within the recess 18 to couple the bowl 16 to the housing 12. The present invention anticipates the first connector 56 and the second connector 58 together comprising other connecting means suitable to particular configurations of the assembly 10, such as, but not limited to, magnetic connectors, detent connectors, and the like.

The assembly 10 also comprises a lid 64, which is selectively engageable to the bowl 16 to close the top 32. The lid 64 may be substantially transparent and thus configured for viewing of the article that is positioned in the bowl 16. A fastening unit 66 is configured to be selectively engageable to the lid 64 and the bowl 16 to secure the lid 64 to the bowl 16. The fastening unit 66 may comprise a clip 68, or other fastening means, such as, but not limited to, locking rings, latches, and the like. The clip 68 is positioned for insertion of a first lip 70, which extends radially from a perimeter 72 of the top 32 of the bowl 16, and a second lip 74, which extends radially from the lid 64. A handle 76 is coupled to the lid 64 and is configured to be grasped in a hand of a user to manipulate the lid 64.

A heating unit 78 is coupled to the housing 12 and is positioned adjacent to the recess 18. The heating unit 78 is configured to selectively warm the bowl 16 and the article that is positioned therein. The heating unit 78 may comprise a heating element 80, as shown in FIG. 4. The heating unit 78 of the assembly 10 may be powered by means of a power cord 82, as shown in FIG. 1. The present invention also anticipates the heating unit 78 being battery powered.

In use, ice and water 24 are added through the orifice 34 into the interior space 14, and the orifice 34 is closed using the panel 38. The lower sidewall 28 is inserted into the recess 18 and the bowl 16 is rotated relative to the housing 12 so that the tab 62 engages the track 60 to secure the bowl 16 to the housing 12. The article is added to the bowl 16 and the lid 64 is secured to the bowl 16, using the clip 68, to close the top 32. Heat transfer between the ice water and the article keeps the article cool. When it is desired to maintain the article in a warm state, the heating element 80 can be used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A temperature controlled storage assembly comprising:
a housing defining an interior space, the housing having a recess extending into an upper face thereof, the housing being configured for selectively positioning a thermal energy storage material in the interior space; and
a bowl comprising a bottom having a lower sidewall coupled thereto and extending therefrom, the lower sidewall having an upper sidewall coupled thereto and extending therefrom defining a top of the bowl, the top being open wherein the top is configured for insertion of an article into the bowl, the lower sidewall being configured for inserting into the recess and for selectively engaging the housing wherein at least one of the bottom and the lower sidewall of the bowl is configured for heat transfer between the thermal energy storage material and the article.

2. The temperature controlled storage assembly of claim 1, further including:
the housing having an orifice positioned in the upper face between the recess and a circumference of the upper face wherein the orifice is configured for addition of the thermal energy storage material to the interior space; and
a panel hingedly engaged to the housing proximate to the orifice, the panel being configured for selectively engaging the housing for closing the orifice.

3. The temperature controlled storage assembly of claim 1, wherein the housing is substantially disc shaped.

4. The temperature controlled storage assembly of claim 1, wherein the recess is substantially circularly shaped.

5. The temperature controlled storage assembly of claim 2, further including:
a cutout positioned in a lower face of the housing such that the cutout is positioned for draining the thermal energy storage material from the interior space; and
a plug selectively engageable to the housing by insertion into the cutout such that the plug is positioned for closing the cutout.

6. The temperature controlled storage assembly of claim 1, wherein the upper sidewall is insulated.

7. The temperature controlled storage assembly of claim 1, wherein the upper sidewall comprises an inner wall and an outer wall defining an internal space, the internal space being substantially occupied by an insulator.

8. The temperature controlled storage assembly of claim 1, further including:
a first connector engaged to the lower sidewall; and
a second connector engaged to the housing within the recess, the second connector being complementary to the first connector such that the second connector is positioned for selectively engaging the first connector for coupling the bowl to the housing.

9. The temperature controlled storage assembly of claim 4, further including:
a first connector engaged to the lower sidewall; and
a second connector engaged to the housing within the recess, the second connector being complementary to the first connector such that the second connector is positioned for selectively engaging the first connector for coupling the bowl to the housing.

10. The temperature controlled storage assembly of claim 9, wherein the second connector comprises a track and the first connector comprises a tab such that the track is positioned for inserting the tab as the lower sidewall of the bowl is rotated within the recess.

11. The temperature controlled storage assembly of claim 1, further including a lid selectively engageable to the bowl for closing the top.

12. The temperature controlled storage assembly of claim 11, wherein the lid is substantially transparent wherein the lid is configured for viewing the article positioned in the bowl.

13. The temperature controlled storage assembly of claim 11, further including a fastening unit configured to be selectively engageable to the lid and the bowl for securing the lid to the bowl.

14. The temperature controlled storage assembly of claim 13, wherein the fastening unit comprises a clip positioned for insertion of a first lip extending radially from a perimeter of the top of the bowl and a second lip extending radially from the lid.

15. The temperature controlled storage assembly of claim 11, further including a handle coupled to the lid wherein the handle is configured for grasping in a hand of a user for manipulating the lid.

16. The temperature controlled storage assembly of claim 1, further including a heating unit coupled to the housing and positioned adjacent to the recess wherein the heating unit is configured for selectively warming the bowl and the article positioned therein.

17. The temperature controlled storage assembly of claim 16, wherein the heating unit comprises a heating element.

18. A temperature controlled storage assembly comprising:
a housing defining an interior space, the housing having a recess extending into an upper face thereof, the housing being configured for selectively positioning a thermal energy storage material in the interior space, the housing having an orifice positioned in the upper face between the recess and a circumference of the upper face wherein the orifice is configured for addition of the thermal energy storage material to the interior space, the housing being substantially disc shaped, the recess being substantially circularly shaped;
a panel hingedly engaged to the housing proximate to the orifice, the panel being configured for selectively engaging the housing for closing the orifice;
a cutout positioned in a lower face of the housing such that the cutout is positioned for draining the thermal energy storage material from the interior space;
a plug selectively engageable to the housing by insertion into the cutout such that the plug is positioned for closing the cutout;
a bowl comprising a bottom having a lower sidewall coupled thereto and extending therefrom, the lower sidewall having an upper sidewall coupled thereto and extending therefrom defining a top of the bowl, the top being open wherein the top is configured for insertion of an article into the bowl, the lower sidewall being configured for inserting into the recess and for selectively engaging the housing wherein at least one of the bottom and the lower sidewall of the bowl is configured for heat transfer between the thermal energy storage material and the article, the upper sidewall being insulated, the upper sidewall comprising an inner wall and an outer wall defining an internal space, the internal space being substantially occupied by an insulator;
a first connector engaged to the lower sidewall;
a second connector engaged to the housing within the recess, the second connector being complementary to the first connector such that the second connector is positioned for selectively engaging the first connector for coupling the bowl to the housing, the second connector comprising a track and the first connector comprising a tab such that the track is positioned for inserting the tab as the lower sidewall of the bowl is rotated within the recess;
a lid selectively engageable to the bowl for closing the top, the lid being substantially transparent wherein the lid is configured for viewing the article positioned in the bowl;
a fastening unit configured to be selectively engageable to the lid and the bowl for securing the lid to the bowl, the fastening unit comprising a clip positioned for insertion of a first lip extending radially from a perimeter of the top of the bowl and a second lip extending radially from the lid;
a handle coupled to the lid wherein the handle is configured for grasping in a hand of a user for manipulating the lid;
a heating unit coupled to the housing and positioned adjacent to the recess wherein the heating unit is configured for selectively warming the bowl and the article positioned therein, the heating unit comprising a heating element.
